(19) United States
(12) Patent Application Publication
(10) Pub. No.: US 2026/0219812 A1
(43) Pub. Date: Jul. 30, 2026

(54) PRINTING SYSTEM

(71) Applicant: SEIKO EPSON CORPORATION, Tokyo (JP)

(72) Inventors: Masayuki KOBAYASHI, Fujimi-machi (JP); Takashi SERA, Shiojiri (JP); Kohei YAMAMOTO, Matsumoto (JP); Katsuhito KITAHARA, Matsumoto (JP)

(21) Appl. No.: 19/460,429

(22) Filed: Jan. 27, 2026

(30) Foreign Application Priority Data
Jan. 29, 2025 (JP) 2025-012815

(51) Int. Cl. G06F 3/12

(52) U.S. Cl. CPC G06F 3/1204; G06F 3/1259; G06F 3/1292

(57) ABSTRACT

A printing system includes: a printing control server; and a management server, in which the printing control server includes a printing request acquisition section that acquires, via a chat server and the management server, image data indicating an image of a print target posted to a chat room displayed on a first terminal device, and a printing request section that transmits the image data to a printer and requests printing, and the management server includes an image data management section that stores the acquired image data in a storage medium, and a display control section that, when a display request to display, on a second terminal device different from the first terminal device, the image is acquired from the second terminal device, transmits, to the second terminal device, the image data stored in the storage medium to display, on the second terminal device, the image indicated by the image data.

The present application is based on, and claims priority from JP Application Serial Number 2025-012815, filed January 29, 2025, the disclosure of which is hereby incorporated by reference herein in its entirety.

### BACKGROUND

### 1. Technical Field

The present disclosure relates to a printing system.

### 2. Related Art

In the related art, chat services provided on SNS and the like are known. For example, JP-A-2019-050519 describes an example in which an image is printed by a multifunction peripheral through a dialogue with a chatbot.

However, in a configuration of the related art, other users who cannot view a chat screen cannot view an image posted to the chat screen, and improvement in convenience is desired.

### SUMMARY

According to an aspect of the present disclosure, there is provided a printing system including: a printing control server; and a management server, in which the printing control server includes a printing request acquisition section that acquires, via a chat server and the management server, image data indicating an image of a print target posted to a chat room displayed on a first terminal device, and a printing request section that transmits the image data to a printer and requests printing, and the management server includes an image data management section that stores the acquired image data in a storage medium, and a display control section that, when a display request to display, on a second terminal device different from the first terminal device, the image indicated by the image data is acquired from the second terminal device, transmits, to the second terminal device, the image data stored in the storage medium to display, on the second terminal device, the image indicated by the image data.

### BRIEF DESCRIPTION OF THE DRAWINGS

FIG. 1 is a block diagram of a printing system.

FIG. 2 is a diagram showing an example of a chat room.

FIG. 3 is a diagram showing a configuration example of data stored in a management server.

FIG. 4 is a sequence diagram showing an example of a flow of posting, printing, and displaying an image.

FIG. 5 is a diagram showing a display example of a list of images posted to a chatbot.

FIG. 6 is a sequence diagram showing an example of a display process of a printing status.

FIG. 7 is a diagram showing a display example of the printing status.

FIG. 8 is a sequence diagram showing an example of processing when an error occurs.

FIG. 9 is a sequence diagram showing an example of processing of image deletion.

### DESCRIPTION OF EMBODIMENTS

Here, embodiments of the present disclosure will be described in accordance with the following order.

1. Configuration of Printing System:

1-1. Configuration of Management Server:

1-2. Configuration of Printing Control Server:

2. Sequence:

3. Other Embodiments:

### 1. Configuration of Printing System:

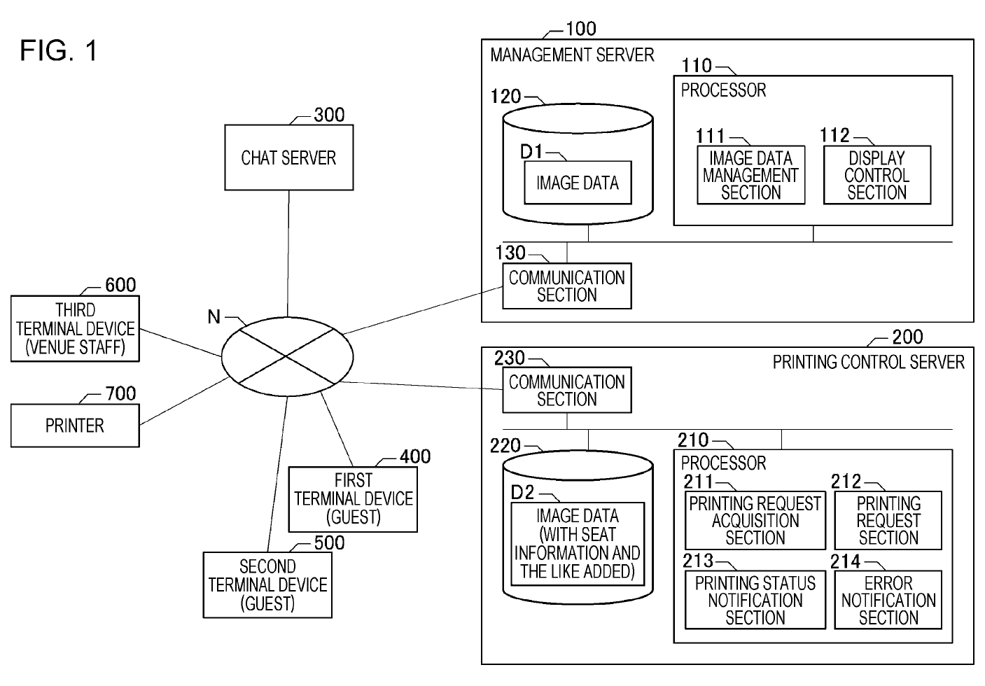

FIG. 1 is a block diagram showing a configuration of a printing system according to an embodiment of the present disclosure. The printing system includes a management server 100 and a printing control server 200. The management server 100 and the printing control server 200 can communicate with each other via a network N. In addition, the management server 100 can communicate with a chat server 300 via the network N. The chat server 300 is a server that provides a chat service in which messages are exchanged with a counterpart in a conversational format. A user of the chat service installs, on a terminal device owned by the user, an application for using the chat service (a chat application) and creates a user account in the chat service. By executing the chat application, the terminal device communicates with the chat server 300.

A first terminal device 400, a second terminal device 500, and a third terminal device 600 are terminal devices on which the chat application is installed. The first terminal device 400, the second terminal device 500, and the third terminal device 600 are, for example, smartphones, tablets, PCs, or the like. In the present embodiment, the first terminal device 400 and the second terminal device 500 are assumed to be portable terminals such as smartphones owned by guests invited to a wedding reception, and the third terminal device 600 is assumed to be a terminal operated by staff of a venue of the reception. A printer 700 is a printer installed in the venue of the reception.

In the present embodiment, for example, an organizer side of the reception creates in advance a chat-service account that is a chatbot account for cooperation with the management server 100 or the printing control server 200. When a guest of the reception arrives at the venue, the guest uses a terminal device such as the guest's smartphone to read a two-dimensional code placed on the guest's table or seat. The two-dimensional code includes information for launching the chat application on the terminal device, the above-described chatbot account, and seat information indicating a seat on which the two-dimensional code read by the smartphone of the guest is placed. In the present embodiment, the seat information is assumed to be a table number of a table corresponding to a seat at which the guest sits, but, in another embodiment, the seat information may be identification information of the seat itself. When the guest reads the two-dimensional code using the guest's smartphone, the chat application is launched on the smartphone, and selection as to whether or not to approve the above-described chatbot account as a chat counterpart is requested. When the guest selects approval, the guest can use a printing service using chat with the chatbot. The printing service using chat with the chatbot is as follows.

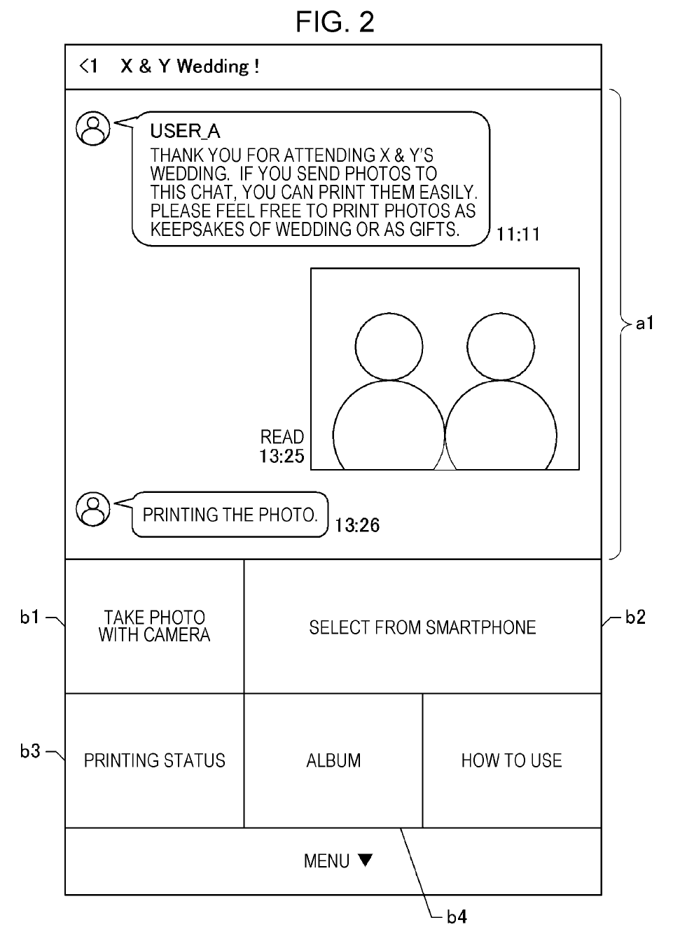

The guest captures, using a camera on the guest's terminal device, images of scenes at the wedding or the reception while participating in the wedding or the reception. The guest posts, in a chat room with the chatbot as shown in FIG. 2, among the captured images, a photograph that the guest desires to take home as printed matter. By sending an image to the chatbot, the printer 700 prepared in the venue of the reception prints the image, and the guest can use a service in which the guest receives the printed photograph.

The chat room is a screen displayed by the chat application, and messages or files exchanged in a conversational format are displayed in chronological order. The chat room in which chat communication is performed with the chatbot account prepared by the organizer side of the reception is created for each user account of the guest. That is, for example, a chat room between a user of the first terminal device 400 and the chatbot is not viewable on the chat application of a user of the second terminal device 500 by the user of the second terminal device 500. Conversely, a chat room between the user of the second terminal device 500 and the chatbot is not viewable on the chat application of the user of the first terminal device 400 by the user of the first terminal device 400.

The printer 700 is a printing device that can print photographs. The printer 700 communicates with the printing control server 200 and the like via the network N. When the printer 700 receives image data from the printing control server 200, the printer 700 performs printing on a printing medium such as photo paper based on the image data. When printing is performed by the printer 700, the guest can receive, from venue staff, printed matter that the guest causes to be printed.

### 1-1. Configuration of Management Server:

The management server 100 is a server having a management function of acquiring and managing, via the chat server 300, image data D1 transmitted from the terminal device of the guest. Specific contents will be described below. The management server 100 includes a processor 110, a storage medium 120, and a communication section 130. The processor 110 includes a CPU, a ROM, a RAM, and the like, and various programs stored in the ROM or the storage medium 120 can be executed by the CPU. The communication section 130 is a communication interface for communicating with other devices. The management server 100 can communicate, via the communication section 130, with other devices connected to the network N. In the storage medium 120, the image data D1 transmitted from the terminal device as a print target is accumulated.

In order to implement the management function, the processor 110 executes a management program (not shown). By executing the management program, the processor 110 requests the printing control server 200 to perform printing when the processor 110 receives the image data from the terminal device via the chat server 300. In addition, by executing the management program, the processor 110 also functions as an image data management section 111 and a display control section 112.

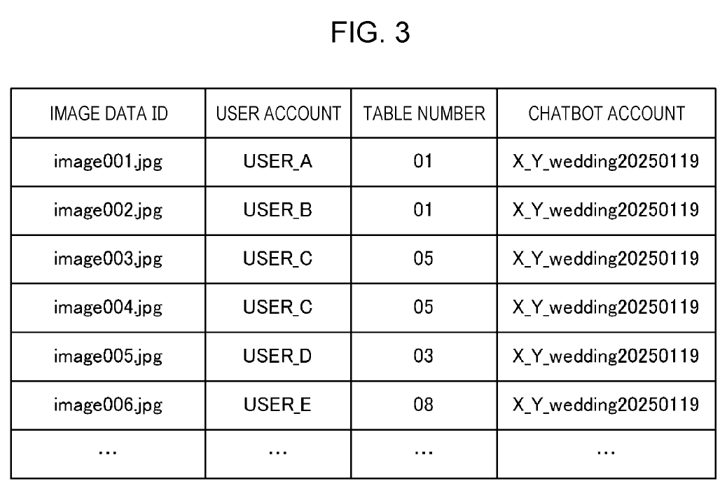

The image data management section 111 causes the processor 110 to implement a function of storing, in the storage medium 120, the image data D1 acquired from the terminal device via the chat server 300. FIG. 3 is a diagram showing a configuration example in which the image data D1 is stored in association with various information. When the user of the terminal device reads the two-dimensional code placed on the table in the venue of the reception and approves the chatbot account as the chat counterpart, the management server 100 acquires the user account of the user, the table number as the seat information, and the chatbot account from the chat server 300. The processor 110 of the management server 100 stores the user account, the table information of the user, and the chatbot account in association with each other. When the user transmits the image data D1 to the chatbot, the processor 110 of the management server 100 stores, in association with an ID of the image data D1, the user account of the user who posts the image data D1 to the chat room, the table number of the user, and the chatbot account in association with each other.

Further, when the image data management section 111 acquires the image data D1 from the terminal device via the chat server 300, the image data management section 111 transmits a printing request for the image data D1 to the printing control server 200. In the present embodiment, in order to facilitate sorting work of printed matter or the like, a printing request for image data D2 generated by adding information such as a table number to the image data D1 is transmitted to the printing control server 200.

The display control section 112 causes the processor 110 to implement a function of transmitting the image data D1 accumulated in the storage medium 120 to a terminal device in response to a display request from the terminal device, and of displaying, on the terminal device, the image data D1 for viewing by the user of the terminal device. As described above, although the chat room with the chatbot is not viewable by other users who perform chat communication with the same chatbot, in the present embodiment, images posted by a plurality of users who are guests of the reception with respect to the same chatbot are made public as an album. That is, by a function of the display control section 112, when a display request to display, on the second terminal device 500 different from the first terminal device 400 that transmits the image data D1, the image indicated by the image data D1 is acquired from the second terminal device 500, the processor 110 transmits, to the second terminal device 500, the image data D1 stored in the storage medium 120 to display, on the second terminal device 500, the image indicated by the image data D1.

Therefore, with the printing system of the present embodiment, in a system in which an image can be printed by the printer associated with the chatbot by posting the image in the chat room with the chatbot, images posted to the chat room can be made viewable by users other than a poster. Accordingly, for example, a sense of unity among event participants can be fostered, and the participants can enjoy viewing various scenes from angles that the participants cannot observe on their own.

### 1-2. Configuration of Printing Control Server:

In the present embodiment, the printing control server 200 is a server having a printing control function of acquiring, via the chat server 300 and the management server 100, the image data D1 transmitted from the terminal device of the guest, and of causing the printer 700 to execute printing based on the image data. The printing control server 200 includes a processor 210, a storage medium 220, and a communication section 230. The processor 210 includes a CPU, a ROM, a RAM, and the like, and various programs stored in the ROM or the storage medium 220 are executed by the CPU. The communication section 230 is a communication interface for communicating with other devices. The printing control server 200 can communicate, via the communication section 230, with other devices connected to the network N. In the storage medium 220, the image data D2 generated based on the image data D1 of the print target that is acquired from the terminal device via the chat server 300 and the management server 100 is stored.

By executing a printing control program (not shown) for implementing the printing control function, the processor 210 functions as a printing request acquisition section 211, a printing request section 212, a printing status notification section 213, and an error notification section 214.

The printing request acquisition section 211 has a function of acquiring, via the chat server 300 and the management server 100, the image data indicating the image of the print target that is posted to the chat room displayed on the first terminal device. The printing request section 212 has a function of transmitting, to the printer 700, the image data D2 generated based on the image data D1, and of requesting printing.

The printing status notification section 213 has a function of transmitting, to the first terminal device 400 that transmits the image data D1 of the print target, information indicating a printing status of printing based on the image data, and of displaying the printing status on the first terminal device. The error notification section 214 has a function of acquiring error information from the printer 700, and of notifying the third terminal device 600 of the error information via the chat server 300. The third terminal device 600 is a terminal device used by venue staff. Hereinafter, details of each section will be described with reference to the sequences.

### 2. Sequence:

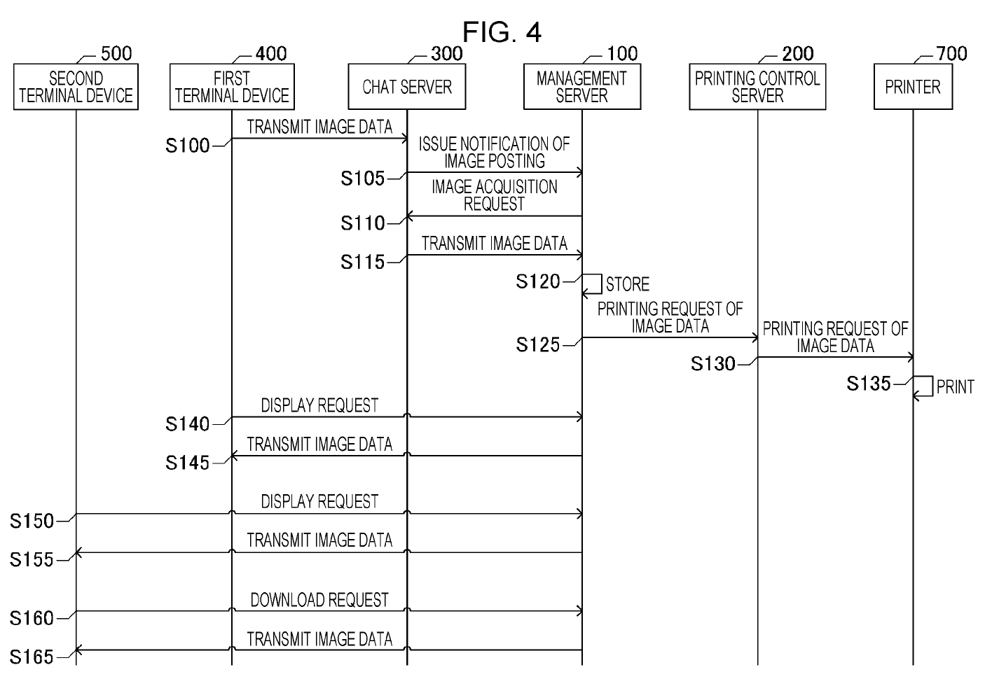

FIG. 4 is a sequence chart showing an example of a flow from image posting to printing and a flow of album display. The sequence of FIG. 4 assumes that the guest of the reception reads a two-dimensional code placed at the guest's seat in the venue of the reception and that approval of the chatbot account is complete. When the user of the terminal device performs approval of the chatbot account, the terminal device transmits, via the chat server 300, to the management server 100, the user account of the chat application of the user of the terminal device, the table information included in the read two-dimensional code, and the chatbot account. When the processor 110 of the management server 100 receives the information, the processor 110 stores, in the storage medium 120, the user account of the chat application of the user, the table information of the user, and the chatbot account in association with each other.

When the user of the first terminal device 400 launches the chat application and opens the chat room with the chatbot, as shown in FIG. 2, an area a1 in which chat with the chatbot is displayed, and, at a lower part of the screen, a button b1 for launching a camera, a button b2 for selecting an image already captured by the terminal device, a button b3 for confirming a printing status, and a button b4 for viewing an album are displayed.

In the chat room, only one chatbot account and the user's own account on the terminal device are registered. Another guest who participates in the wedding or the reception also approves the same chatbot as a chat communication counterpart; however, in the chat application of the other guest as well, only the chatbot account and the other guest's own account are registered in the chat room with the chatbot. In this way, only the chatbot and the user's account are displayed in the chat room as participants in the chat room, and other users who register the same chatbot are not displayed as participants in the chat room in which the user participates. Depending on specifications of the chat server and the chat application, when the user account is obtainable, profile information of the user of the user account, for example, a display name, a cover photo, and the like, is viewable. According to the present embodiment, as described above, since the user account in the user's chat application is not displayed in a chat room with the chatbot of another user, a possibility that profile information in the user's chat application is known to another user can be reduced.

The user can select the button b1, capture scenes of the wedding, the reception, and the venue using the launched camera, and post captured images to the chat room; or the user can select the button b2, display a list of images already captured and stored on the user's terminal device, and select from the list an image to be printed, and post the image to the chat room.

When the user posts the image to be printed to the chat room by using any one of the above-described methods, the first terminal device 400 transmits, to the chat server 300, the image data D1 indicating the image (step S100). When the chat server 300 receives the image data D1, the chat server 300 notifies the management server 100 that the image is posted (step S105). When the processor 110 of the management server 100 receives the notification of step S105, the processor 110 transmits, to the chat server 300, an image acquisition request (step S110). In response to the request of step S110, the chat server 300 transmits the image data D1 to the management server 100 (step S115). Specifically, for example, the chat server 300 transmits, to the management server 100, the image data D1, the user account of the user who posts the image, and the chatbot account.

When the image data and the like are received in step S115, the processor 110 of the management server 100 stores the received image data D1 in the storage medium 120 via the image data management section 111 (step S120). That is, the processor 110 stores the user account and the chatbot account in association with the ID of the received image data D1. In addition, the processor 110 stores, in association with the image data ID, the table number that is stored in association with the user account and the chatbot account.

Subsequently, the processor 110 of the management server 100 transmits the image data D2 to the printing control server 200 and requests printing of the image data D2 (step S125). Specifically, the processor 110 transmits, to the printing control server 200, the image data D2 obtained by adding, to the image data D1, the table number and the user account that are associated with the image data, and the chatbot account.

Here, adding the user account and the table number to the image data D1 is to dispose character strings indicating the user account, character strings indicating the table number, and the like, in a superimposed manner on the image indicated by the image data or outside an area of the image indicated by the image data. The image data D2 is image data in which these character strings are disposed on the image data D1 in this manner. The character strings indicating the user account may be added, for example, in a masked state in which at least a part is replaced with wildcard characters or the like. Alternatively, character strings indicating the display name of the user account on the chat application of the user may be added to the image data D1 in place of the user account, and at least a part of the display name may be added in a masked state with wildcard characters or the like.

When the processor 210 of the printing control server 200 acquires the printing request of step S125 by the function of the printing request acquisition section 211, the processor 210 requests printing by transmitting the image data D2 to the printer 700 (step S130). The printer 700 performs printing based on the image data D2 received in step S130 (step S135).

In this way, in the printing system, by causing the printer 700 to print the image data to which the seat information is added, it is possible to reduce, based on the seat information, the effort required for sorting work of the printed matter by venue staff and for handover work. Similarly, by causing the printer 700 to print the image data to which the user account of the user who posts the image is added, it is possible to reduce, based on the user account, the effort required for sorting work and for handover work.

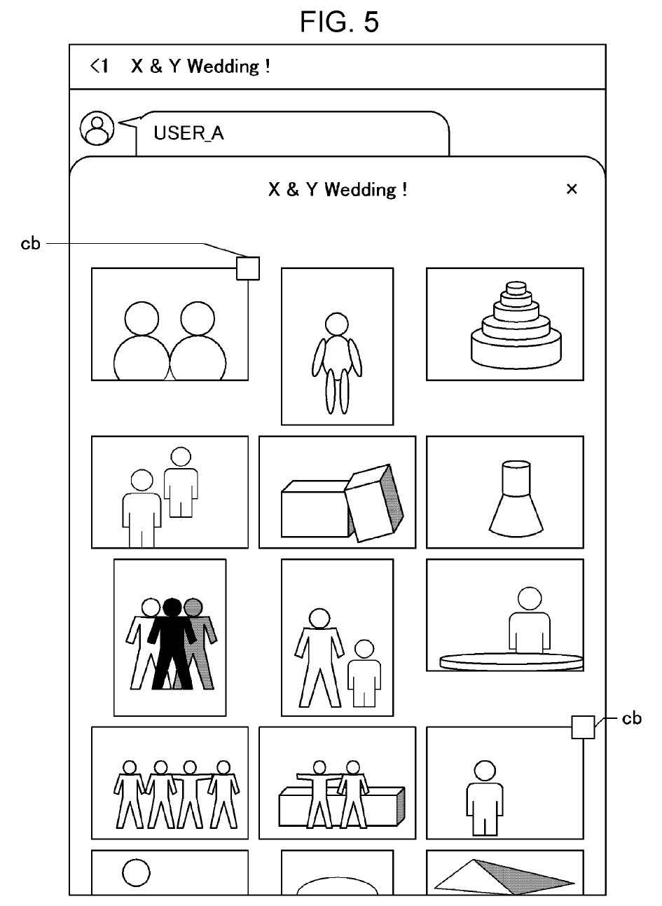

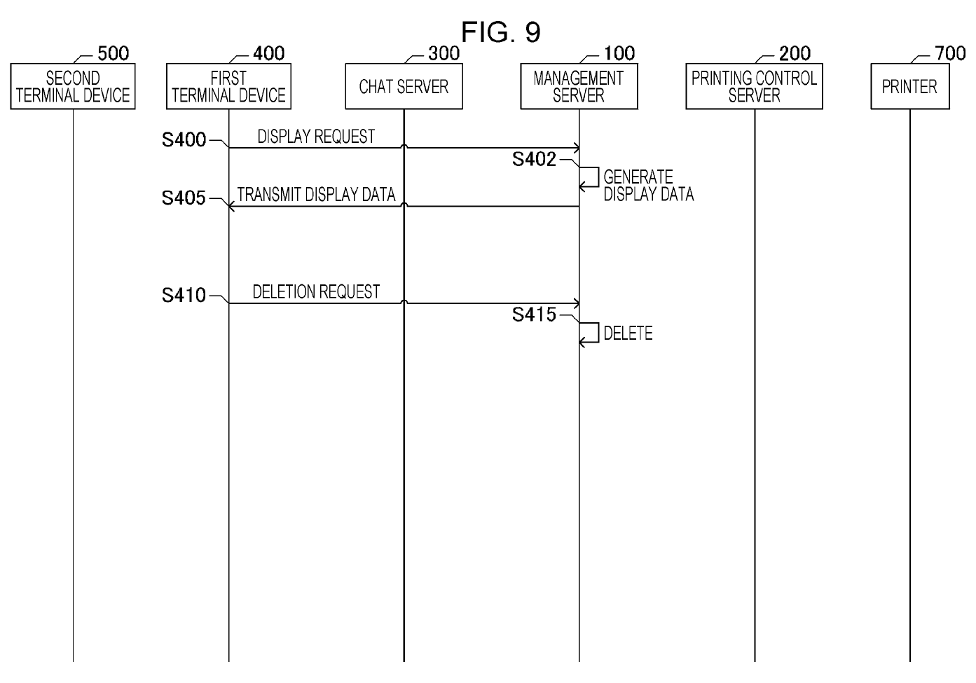

After the image data D1 is transmitted from the first terminal device 400 to the chat server 300 in step S100, when the button b4 for album viewing is selected on the first terminal device 400, the first terminal device 400 transmits the display request to the management server 100 (step S140). Specifically, the first terminal device 400 transmits the display request together with the user account of the chat application and the chatbot account. Upon receiving the display request of step S140, the processor 110 of the management server 100 transmits the image data D1 indicated by the image data ID that is stored in the storage medium 120 in association with the chatbot account (step S145). Specifically, the processor 110 transmits thumbnail image data obtained by resizing the stored image data D1 to a low resolution. When only one piece of image data D1 is stored, the corresponding one piece of thumbnail image data is transmitted. When a plurality of pieces of image data D1 are stored, the plurality of corresponding pieces of thumbnail image data are transmitted. The first terminal device 400 displays a list of the transmitted image data in a browser of the chat application. FIG. 5 shows a display example displayed when the album button b4 is selected, in which a list of images stored in association with the chatbot account is displayed. The list includes images posted by the user who selects the album button b4, that is, the user who made the display request. Note that the user account transmitted together with the display request in step S140 and in step S150 to be described next is used to determine which image is deletable by the user who made the display request. Details of deletion will be described below with reference to FIG. 9.

In addition, when the user of the second terminal device 500 selects the album button b4, the second terminal device 500 transmits the display request to the management server 100 (step S150). Specifically, the second terminal device 500 transmits the display request together with the user account of the chat application and the chatbot account. Upon receiving the display request of step S150, the processor 110 of the management server 100 transmits the image data indicated by the image data ID that is stored in the storage medium 120 in association with the chatbot account (step S155). As a result, a list of the image data is also displayed on the second terminal device 500, in the browser of the chat application. When no image is posted by the user of the second terminal device 500 to the chat room with the chatbot, all of the displayed images are images posted by other users. Of course, this includes the image transmitted in step S100 from the first terminal device 400. In this way, with the printing system of the present embodiment, images posted to the chat room can be made viewable also by users other than the poster.

In addition, when a list as shown in FIG. 5 is displayed on, for example, the second terminal device 500, and the user of the second terminal device 500, for example, long-presses any image, the second terminal device 500 specifies the image selected by the long press and transmits, to the management server 100, a download request for the specified image (step S160). Upon receiving the download request, the processor 110 of the management server 100 transmits, to the second terminal device 500 that is a transmission source of the download request, image data indicating the requested image (step S165). The download request may be for an image posted by the user of the terminal device that transmits the download request or may be for an image posted by another user. In this way, with the printing system of the present embodiment, the image data accumulated in the management server 100 can be downloaded to the terminal device in response to the download request from the terminal device. The printing system may be configured such that a plurality of images are selectable for batch download. For example, after the reception, when the bride and the groom desire to download images accumulated in the management server 100 in a batch as keepsakes and to store the images on their own terminals, such a requirement can be met.

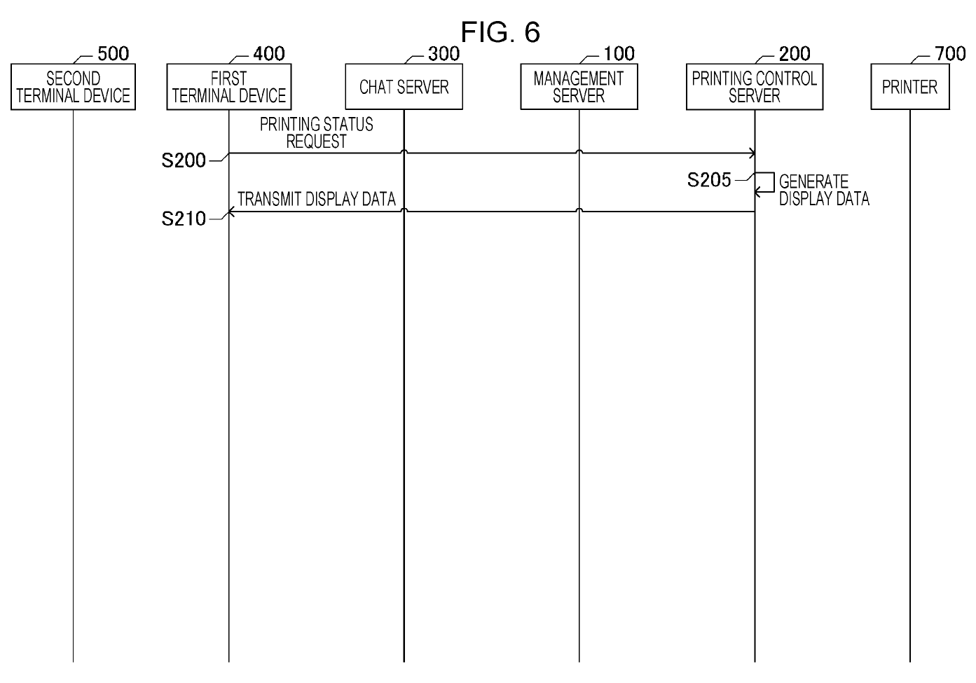

Next, a sequence for confirming the printing status will be described with reference to FIG. 6. After processing of step S100 to step S135 shown in FIG. 4 is performed, when the user of the first terminal device 400 selects the button b3 shown in FIG. 2, the first terminal device 400 transmits a printing status request to the printing control server 200 (step S200). Specifically, the first terminal device 400 transmits the printing status request together with the user account of the chat application of the user of the first terminal device 400. Upon receiving the request of step S200, the processor 210 of the printing control server 200 generates display data for displaying a printing status by a function of the printing status notification section 213 (step S205) and transmits the display data to the first terminal device 400 (step S210). That is, the processor 210 transmits, to the first terminal device 400 that transmits the image data of the print target, information indicating the printing status of printing based on the image data, thereby displaying the printing status on the first terminal device 400.

Specifically, the processor 210 of the printing control server 200 confirms a print-waiting queue that accumulates, in order of reception, image data waiting for output to the printer 700. In addition to the print-waiting queue, the processor 210 of the printing control server 200 accumulates, in the storage medium 220 as a log, a file name indicating the image data in association with a reception date and time received by the printing control server 200 and a user account of a printing request source. The processor 210 refers to the log and specifies image data associated with the user account that makes the printing status request. When the specified image data is not present in the print-waiting queue, the processor 210 determines that the image data is printed. Additionally, when the specified image data is present at a head of the print-waiting queue, the processor 210 determines that the image data is being printed. Further, when image data associated with the user account is present at a second or later position in the print-waiting queue, the processor 210 determines that the image data is waiting to be printed. Then, the processor 210 generates the display data indicating the printing status of the image data corresponding to the user account of the request source and transmits the display data to the first terminal device 400.

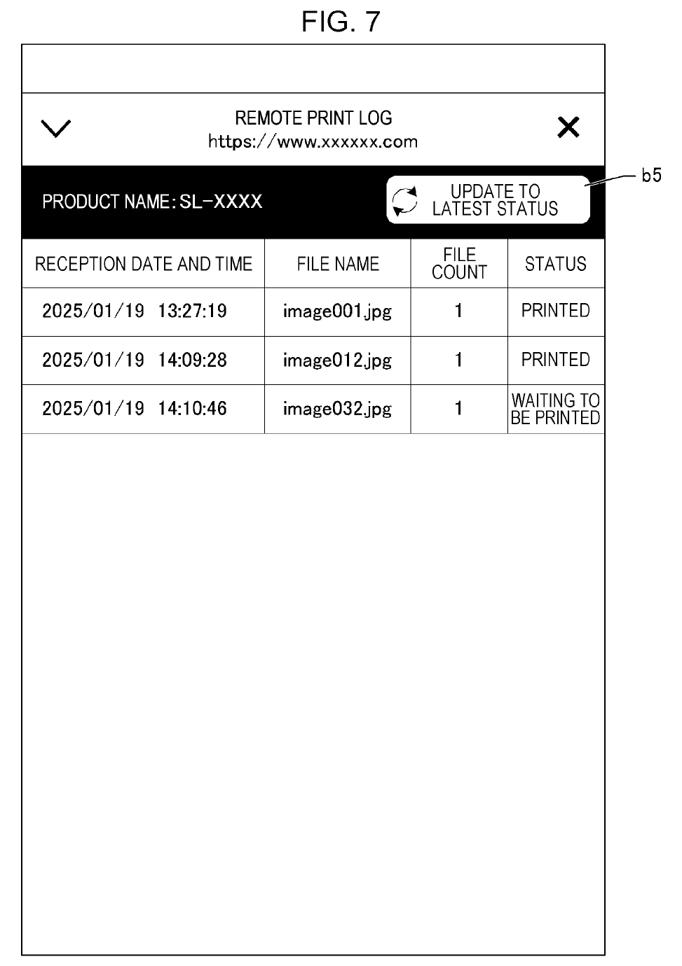

FIG. 7 shows a display example of the printing status displayed on the first terminal device 400 based on the display data received in step S210. When the user selects a display update button b5, the processing from step S200 shown in FIG. 6 is executed again. In this way, with the printing system of the present embodiment, the user can ascertain the printing status of the image posted by the user.

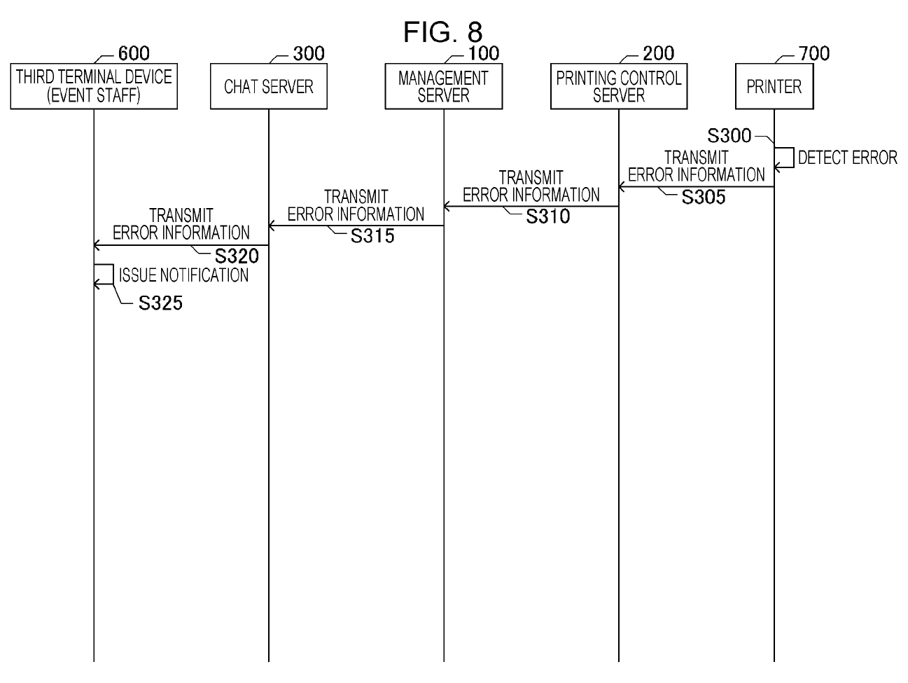

FIG. 8 shows a sequence example when an error occurs during execution of printing in the printer 700. The printing control server 200 periodically inquires of the printer 700 about a state of the printer 700. When the printer 700 detects occurrence of an error (step S300), the printer 700 transmits, to the printing control server 200, error information indicating the occurrence of the error (step S305). Here, the error includes, for example, errors that do not allow printing to continue, such as paper jams, insufficient remaining ink, and insufficient remaining printing medium. The error information includes identification information of the printer in which the error occurs and information indicating a type of the error that occurs.

When the printing control server 200 receives the error information from the printer 700, the printing control server 200 transmits the error information to the management server 100 (step S310). The management server 100 transmits the error information to the chat server 300 (step S315). In the management server 100, the user account of the chat application of venue staff of the venue in which the printer 700 is installed is stored. When the management server 100 receives the error information regarding the printer 700, the management server 100 specifies the user account of venue staff associated with identification information of the printer included in the error information and, for example, in step S315, transmits the error information, in a form of chat of the chat application, to the user account. The chat server 300 transmits the error information to the third terminal device 600 of the venue staff (step S320). When the third terminal device 600 receives the error information, the third terminal device 600 issues a notification of reception of chat of the chat application (step S325) and, in accordance with an operation of the user to confirm details of the notification, displays the error information on the third terminal device. In this way, with the printing system of the present embodiment, when an error occurs, the user of the third terminal device 600 can be notified of the error information. As a result, venue staff can be supported in promptly taking measures on the printer 700 to resolve the error.

FIG. 9 is a sequence example when an image posted by the image poster is deleted. Steps S400 to S405 of FIG. 9 are similar to steps S140 and S145 of FIG. 4; more specifically, in step S400, the management server 100 specifies the user account of a display request source and specifies image data that is stored in association with the user account. Then, the management server 100 generates display data for list display, in a manner indicating that image data associated with the user account is deletable by the user of the user account (step S402), and the management server 100 transmits the display data to the first terminal device 400. Specifically, for example, as shown in FIG. 5, for images posted by the user of the first terminal device 400, display data in which a check box cb is disposed is generated. The check box cb indicates that the image is deletable by the user of the first terminal device 400. When the user of the first terminal device 400 checks a check box of the user's posted image to be deleted and selects a deletion button (not shown), the first terminal device 400 transmits, to the management server 100, a deletion request for the checked image (step S410). When the management server 100 receives the deletion request, the management server 100 deletes the requested image data from the storage medium 120 (step S415). In this way, with the printing system of the present embodiment, the user who posts an image can delete the image from the management server 100. Therefore, for example, when an image unrelated to the reception is accidentally posted, a possibility that the image remains in the management server 100 and is viewed by other guests can be reduced.

Note that, as in the example shown in FIG. 5, a configuration may be employed in which the check box cb is displayed for the image associated with the user account of the user of the first terminal device 400 that is the display request source, and an image for which the check box cb is not displayed is undeletable by the user; alternatively, a configuration may also be employed in which the check box cb is not displayed in association with the image, and the management server 100 acquires identification information of an image for which the user makes a deletion request, and performs deletion when the image indicated by the identification information is associated with the user account of the user, and when the image is not associated, a reply is made that deletion cannot be performed because the image is a posted image posted by another user.

### 3. Other Embodiments:

The above embodiment is an example for implementing the present disclosure, and various other embodiments can be employed. For example, the printing control server and the management server may be integrally configured. In addition, for example, the management server may be configured with a plurality of servers, and the printing control server may also be configured with a plurality of servers. Further, in the above-described embodiment, a part of the functions executed by the management server 100 may be performed by the printing control server 200, and a part of the functions executed by the printing control server 200 may be executed by the management server 100. Allocation of processing contents may be determined as appropriate. For example, processing of generating the image data D2 from the image data D1 may be performed by the printing control server 200.

The printing system can be used for various events in addition to the wedding, the reception, and the like described in the above embodiment. For example, the printing system can also be used at a venue such as a concert, a live performance, or a dinner show. The seat information may be information for identifying a seat on which a user sits, identification information for a table corresponding to the seat on which the user sits, or identification information for a block in which the seat on which the user sits is included. In this manner, among photographs printed in large quantities and displayed, event participants can more easily search for photographs posted by the participants. Additionally, venue staff can also sort photographs printed in large quantities based on the seat information so that a poster can easily search for the poster's photographs.

A configuration may be employed in which the number of users registered in one chat room is less than the number of users permitted to transmit the display request of the image posted to the chat room. That is, a configuration may be employed in which the number of users registered in one chat room is less than the number of users permitted to view images posted to the chat room. Therefore, when such a configuration is employed, it is possible to enable users other than users registered in the chat room to view images posted to the chat room. Note that the configuration in which the number of users registered in one chat room is less than the number of users permitted to transmit the display request of the image posted to the chat room is not limited to a configuration in which only one chatbot account and one user account are provided, and for example, a group chat in which one chatbot account and accounts of a plurality of users participate may be used. In that case, a configuration may be employed in which a user who does not participate in the group chat but who approves the chatbot account can view images posted to the group chat.

In the above-described embodiment, only one printer is provided; however, a plurality of printers may be installed at the venue and may be registered in a state capable of cooperation with the printing control server and the printing system. Then, for example, when a printer that is mainly used becomes unable to print due to an error, the printing control server may be configured to switch an output destination to another backup printer to perform printing. Alternatively, the printing control server may be configured to operate a plurality of printers simultaneously in order to improve printing efficiency.

Additionally, the present disclosure is applicable as a program or a method executed by a computer. Further, the systems, programs, and methods as described above may be implemented as a single apparatus or may be implemented by using components provided in a plurality of apparatuses, and include various aspects. In addition, a part may be software and a part may be hardware, and changes can be made as appropriate. Further, the disclosure is also established as a recording medium for a program for controlling the system. Naturally, the recording medium of the program may be a magnetic recording medium or may be a semiconductor memory, and the same applies entirely to any recording medium to be developed in the future.

What is claimed is:

1. A printing system comprising:
a printing control server; and
a management server, wherein
the printing control server includes
a printing request acquisition section that acquires, via a chat server and the management server, image data indicating an image of a print target posted to a chat room displayed on a first terminal device, and
a printing request section that transmits the image data to a printer and requests printing, and
the management server includes
an image data management section that stores the acquired image data in a storage medium, and
a display control section that, when a display request to display, on a second terminal device different from the first terminal device, the image indicated by the image data is acquired from the second terminal device, transmits, to the second terminal device, the image data stored in the storage medium to display, on the second terminal device, the image indicated by the image data.

2. The printing system according to claim 1, wherein
the number of users registered in one chat room is less than the number of users permitted to transmit the display request of the image posted to the chat room.

3. The printing system according to claim 2, wherein
an account indicating one chatbot and one user account are registered in the one chat room.

4. The printing system according to claim 1, wherein
the printing control server includes
a printing status notification section that transmits, to the first terminal device that transmits the image data of the print target, information indicating a printing status of printing based on the image data and displays the printing status on the first terminal device.

5. The printing system according to claim 1, wherein
the image data management section in the management server
stores, in the storage medium, the image data in association with a user account of a user of the first terminal device that transmits the image data of the print target, and
when a deletion request of the image data is received from the first terminal device that transmits the image data of the print target, deletes, from the storage medium, the image data associated with the user account of the user of the first terminal device that transmits the deletion request.

6. The printing system according to claim 1, wherein
the printing control server includes
an error notification section that acquires error information from the printer and notifies a third terminal device of the error information via the chat server.

7. The printing system according to claim 1, wherein
the image data management section of the management server
stores, in the storage medium, a user account in association with seat information of a user indicated by the user account,
stores, in the storage medium, the image data in association with a user account of a user of the first terminal device that transmits the image data of the print target, and
adds, to the image data, seat information associated with the user account of the user of the first terminal device that transmits the image data, and requests the printing control server to perform printing of the image data to which the seat information is added.

8. The printing system according to claim 7, wherein
the image data management section of the management server
adds, to the image data, a user account of a chat service of the user of the first terminal device that transmits the image data of the print target, and requests the printing control server to perform printing of the image data to which the user account is added.

9. The printing system according to claim 1, wherein
in the management server, the display control section
when the display request is acquired, transmits, to the second terminal device, all of the image data that is stored in the storage medium in association with a chatbot account of the chat room to display, on the second terminal device, a list of the images indicated by the image data.

10. The printing system according to claim 1, wherein
the image data management section in the management server
in response to a download request from the first terminal device or the second terminal device, transmits, to the terminal device that is a transmission source of the download request, the image data that is stored in the storage medium in association with a chatbot account of the chat room.

11. The printing system according to claim 1, wherein
the printing control server and the management server are integrated.
